(19) United States
(12) Patent Application Publication
(10) Pub. No.: US 2012/0042359 A1
(43) Pub. Date: Feb. 16, 2012

(54) INFORMATION PROCESSING SYSTEM, WEB SERVER, INFORMATION PROCESSING APPARATUS, CONTROL METHODS THEREFOR, AND PROGRAM

(75) Inventor: Shigeki Kuroda, Yokohama-shi (JP)

(73) Assignee: CANON KABUSHIKI KAISHA, Tokyo (JP)

(21) Appl. No.: 13/185,838

(22) Filed: Jul. 19, 2011

(30) Foreign Application Priority Data
Aug. 16, 2010 (JP) 2010-181855

(51) Int. Cl. G06F 15/16; H04L 9/32

(52) U.S. Cl. 726/3

(57) ABSTRACT

This invention provides an information processing system which sets a validity period of authentication in an Web application provided by a Web server activated from an information processing apparatus in accordance with the logout transition time in the information processing apparatus, a Web server, an information processing apparatus, and control methods therefor. To accomplish this, a Web application activated on a Web server acquires the information of the logout transition time set in an information processing apparatus, and updates the validity period of authentication in the Web application in accordance with the acquired logout transition time. The Web application receives the notification of an operation event occurring in an MFP in addition to an operation event on the Web application, and properly resets a timer for the validity period of authentication in the Web application.

### BACKGROUND OF THE INVENTION

1. Field of the Invention

The present invention relates to an information processing system, a Web server, an information processing apparatus, control methods therefor, and a program.

2. Description of the Related Art

It is known that an information processing apparatus such as a PC is connected to a Web server on a network, and an operation screen provided by the Web server is displayed on the Web browser of the information processing apparatus. In this case, the Web browser of the information processing apparatus issues a request for an operation screen to the Web server. A Web application on the Web server transmits an HTML file for causing the Web browser of the information processing apparatus to display the operation screen in response to the request from the information processing apparatus. The Web browser of the information processing apparatus analyzes the received HTML file and displays the operation screen based on the description of the received HTML file as a Web browser screen. When the user inputs an instruction via the operation screen displayed on the Web browser, the Web browser notifies the Web server of the input instruction. Upon receiving this notification, the Web application on the Web server executes processing in accordance with the input instruction.

Recently, some MFPs (Multi Function Peripherals) including scanners and printers have included a Web browser like that described above. Such an MFP displays the operation screen provided from a Web server on the Web browser of the MFP by using the above procedure, and accepts various kinds of instructions from the user.

Japanese Patent Laid-Open No. 2006-127503 has proposed a technique of making a Web server provide to an MFP an operation screen for inputting instructions for the use of various functions of the MFP. More specifically, the user of the MFP inputs an instruction to the MFP via the operation screen displayed on the Web browser. The Web browser of the MFP notifies the Web server of the input instruction. Upon receiving the notification, the Web server requests the MFP to execute various kinds of processing in accordance with the contents of the instruction input from the user. Upon receiving this request, the MFP executes the requested processing. This eliminates the necessity to hold all menu data for the operation of the MFP in the MFP, and allows menu data to be easily changed on the Web server.

The above conventional technique, however, has the following problems. Some of the above information processing apparatuses such as PCs and MFPs include a function of authenticating a user who operates the information processing apparatus and permitting the user to use the information processing apparatus in accordance with the authentication result. Some of these information processing apparatuses include the function of the auto clear mode of returning an operator panel to the initial state if the user does not operate the apparatus for a predetermined period of time. Some apparatuses further include the function of sleep mode (also called the low-power mode or power save mode) for reducing power consumption.

At the time of transition to the auto clear mode or sleep mode, even if the user has been authenticated and logged in, the apparatus cancels the authenticated state of the login user and automatically makes the user logout. The user can designate a time to transition to the auto clear mode or a time to transition to the sleep mode. Assume that the user has set the time to transition to the sleep mode to 15 minutes. In this case, if the user does not perform any operation for 15 minutes after the last operation, the apparatus makes a transition to the power save mode and performs operations such as blacking out the screen, and at the same time performs logout processing for the login user.

On the other hand, in consideration of security, a Web application interrupts a session if there has been no access (request) from the client for a predetermined period of time, that is, the authentication period has expired (validity period of authentication). Assume that the validity period of authentication is set to 10 min. In this case, if there has been no request from the client for 10 min, the Web application automatically performs logout processing. When the next request occurs, the application transmits an authentication screen to the client to prompt it to perform authentication processing.

Assume that this validity period of authentication is shorter than the sleep mode transition time. In this case, when the user operates the Web application from the Web browser on the operation screen, a page request may be interrupted due to a timeout. In such a case, the user cannot operate the Web browser unless he/she authenticates again. This degrades the user-friendliness. When the user performs general operation on the MFP, a timer for the sleep mode transition time or auto clear mode transition time on the device side is reset. If, however, this user operation accompanies no request to the Web application (for example, pressing the hardware key on the MFP operation unit), the Web application cannot detect the user operation. In addition, a timer indicating the validity period of authentication on the Web application side is not reset even if the user performs the above operation. Eventually, therefore, the validity period of authentication on the Web application side expires first. Furthermore, if the validity period time of authentication on the Web application side is set to infinity (no timeout), there remains apprehension about security. It is therefore required to set a proper validity period time of authentication.

### SUMMARY OF THE INVENTION

The present invention enables realization of an information processing system which sets a validity period of authentication in an Web application provided by a Web server activated from an information processing apparatus in accordance with the logout transition time in the information processing apparatus, a Web server, an information processing apparatus, and control methods therefor.

One aspect of the present invention provides an information processing system comprising a Web server and an information processing apparatus including a Web browser for displaying an operation screen provided by the Web server, the Web server comprising an authentication unit that executes authentication of a user who is to use the Web browser via a screen of the Web browser displayed on the information processing apparatus, a transition time requesting unit that requests a notification from the information processing apparatus of a logout transition time indicating a predetermined period of time which is set in the information processing apparatus and over which if no user operation is received, a user who has logged in to the information processing apparatus is automatically logged out, when authentication by the authentication unit succeeds, and an updating unit that updates a validity period of authentication which is a predetermined period of time over which if user operation by a user authenticated by the authentication unit is not received, authentication of the user is automatically disabled, in accordance with the logout transition time acquired from the information processing apparatus in response to a request from the transition time requesting unit, and the information processing apparatus comprising an authentication requesting unit that requests the Web server to authenticate the user, when the user is to use the Web browser, and a transition time notifying unit that acquires a logout transition time held in advance from a memory and notifies the Web server of the acquired logout transition time, when the transition time requesting unit issues a request to notify the logout transition time.

Another aspect of the present invention provides a Web server which is connected to an information processing apparatus comprising a Web browser, the server comprising: an authentication unit that executes authentication of a user who uses the Web browser via a screen of the Web browser displayed on the information processing apparatus; a transition time requesting unit that requests a notification from the information processing apparatus of a logout transition time indicating a predetermined period of time which is set in the information processing apparatus and over which if no user operation is received, a user who has logged in to the information processing apparatus is automatically logged out, when authentication by the authentication unit succeeds; and an updating unit that updates a validity period of authentication which is a predetermined period of time over which if user operation by a user authenticated by the authentication unit is not received, authentication of the user is automatically disabled, in accordance with the logout transition time acquired from the information processing apparatus in response to a request from the transition time requesting unit.

Still another aspect of the present invention provides an information processing apparatus comprising a Web browser which is connected to a Web server and is used to display an operation screen provided by the Web server, the apparatus comprising: an authentication requesting unit that requests the Web server to authenticate the user, when the user is to use the Web browser; and a transition time notifying unit that acquires a logout transition time held in advance from a memory and notifies the Web server of the acquired logout transition time, when receiving a request to notify the logout transition time indicating a predetermined period of time over which if no user operation is received from the Web server after authentication has been succeeded in the Web server, a user who has logged in to the information processing apparatus is automatically logged out.

Yet still another aspect of the present invention provides a control method for an information processing system including a Web server and an information processing apparatus including a Web browser for displaying an operation screen provided by the Web server, the method comprising: causing an authentication requesting unit of the information processing apparatus to request the Web server to perform authentication processing for a user, when the user is to use the Web browser, causing an authentication unit of the Web server to execute authentication of the user who is to use the Web browser via a screen of the Web browser displayed on the information processing apparatus; causing a transition time requesting unit of the Web server to request a notification from the information processing apparatus of a logout transition time indicating a predetermined period of time which is set in the information processing apparatus and over which if no user operation is received, a user who has logged in to the information processing apparatus is automatically logged out, when authentication in the causing the authentication unit of the Web server to execute succeeds; causing a transition time notifying unit of the information apparatus to acquire a logout transition time held in advance from a memory and notifies the Web server of the acquired logout transition time, when a request to notify the logout transition time is issued in the causing the transmission time requesting unit of the Web server to request; and causing an updating unit of the Web server to update a validity period of authentication which is a predetermined period of time over which if user operation by a user authenticated in executing authentication is not received, authentication of the user is automatically disabled, in accordance with the logout transition time acquired from the information processing apparatus in response to a request in the causing the transmission time requesting unit of the Web server to request.

Still yet another aspect of the present invention provides a control method for a Web server which is connected to an information processing apparatus including a Web browser, the method comprising: causing an authentication unit to execute authentication of a user who uses the Web browser via a screen of the Web browser displayed on the information processing apparatus; causing a transition time requesting unit to request a notification from the information processing apparatus of a logout transition time indicating a predetermined period of time which is set in the information processing apparatus and over which if no user operation is received, a user who has logged in to the information processing apparatus is automatically logged out, when authentication succeeds in the causing the authentication unit to execute; and causing an updating unit to update a validity period of authentication which is a predetermined period of time over which if user operation by a user authenticated in the causing the authentication unit to execute is not received, authentication of the user is automatically disabled, in accordance with the logout transition time acquired from the information processing apparatus in response to a request in the causing the transition time requesting unit to request.

Yet still another aspect of the present invention provides a control method for an information processing apparatus including a Web browser which is connected to a Web server and is used to display an operation screen provided by the Web server, the method comprising: causing an authentication requesting unit to request the Web server to authenticate the user, when the user is to use the Web browser; and causing a transition time notifying unit to acquire a logout transition time held in advance from a memory and notifies the Web server of the acquired logout transition time, when receiving a request to notify the logout transition time indicating a predetermined period of time over which if no user operation is received from the Web server after authentication has been succeeded in the Web server, a user who has logged in to the information processing apparatus is automatically logged out.

Still yet another aspect of the present invention provides a computer-readable storage medium storing a computer program for causing a computer to execute a control method for the information processing system.

Yet still another aspect of the present invention provides a computer-readable storage medium storing a computer program for causing a computer to execute a control method for the Web server.

Still yet another aspect of the present invention provides a computer-readable storage medium storing a computer program for causing a computer to execute a control method for the information processing apparatus.

Further features of the present invention will be apparent from the following description of exemplary embodiments with reference to the attached drawings.

### BRIEF DESCRIPTION OF THE DRAWINGS

FIG. 1 is a view showing an overall information processing system 100 according to the first embodiment;

FIG. 2 is a block diagram showing an example of the arrangement of an MFP 101 according to the first embodiment;

FIG. 3 is a block diagram showing an example of the arrangement of a Web server 103 according to the first embodiment;

FIG. 4 is a block diagram showing an example of a control arrangement for the information processing system 100 according to the first embodiment;

FIG. 5 is a sequence chart showing the processing of updating the validity period of authentication of the information processing system 100 according to the first embodiment;

FIG. 6 is a flowchart showing a processing procedure for a processing request in a Web application 410 according to the first embodiment;

FIG. 7 is a flowchart showing a processing procedure for updating the validity period of authentication in the Web application 410 according to the first embodiment;

FIG. 8 is a sequence chart showing a processing procedure for timer resetting in a Web browser 440 according to the second embodiment;

FIG. 9 is a sequence chart showing a processing procedure for timer resetting in an MFP 101 according to the second embodiment; and

FIG. 10 is a flowchart showing a processing procedure for timer resetting in a native module 460 according to the second embodiment.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

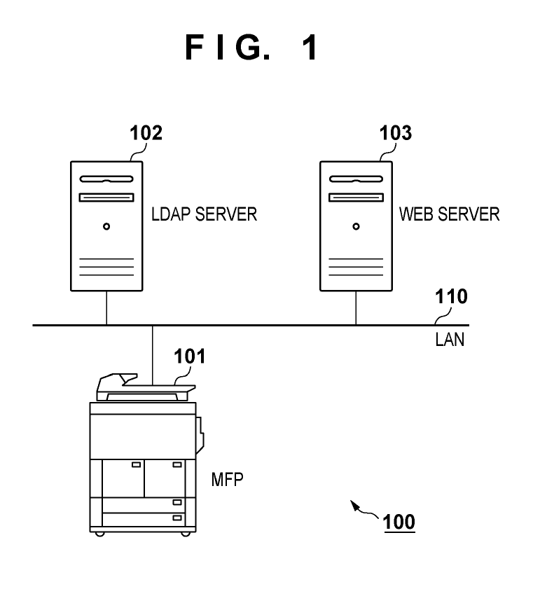

The first embodiment of the present invention will be described below with reference to FIGS. 1 to 7. In this embodiment, an MFP as an example of an information processing apparatus issues a request for an operation screen to a Web application in a Web server using a Web browser. Thereafter, authentication processing is executed in the Web application or the MFP. In addition, the following is an example of how the Web application acquires an MFP logout transition time and properly sets a validity period of authentication.

<Arrangement of Information Processing System>

The overall arrangement of an information processing system 100 according to this embodiment will be described first with reference to FIG. 1. An MFP 101, an LDAP (Lightweight Directory ACCESS Protocol) server 102, a Web server 103 are communicably connected to a LAN 110. The LAN 110 also includes an FTP (File Transfer Protocol) server (not shown) to allow the MFP 101 to perform FTP transmission of image data to the FTP server. Note that this description exemplifies an information processing system according to the embodiment, and there is no intention to limit the types and number of apparatuses. The Web server 103 functions as a server apparatus which provides the screen information of a Web application to the MFP 101 as an information processing apparatus.

<Arrangement of MFP>

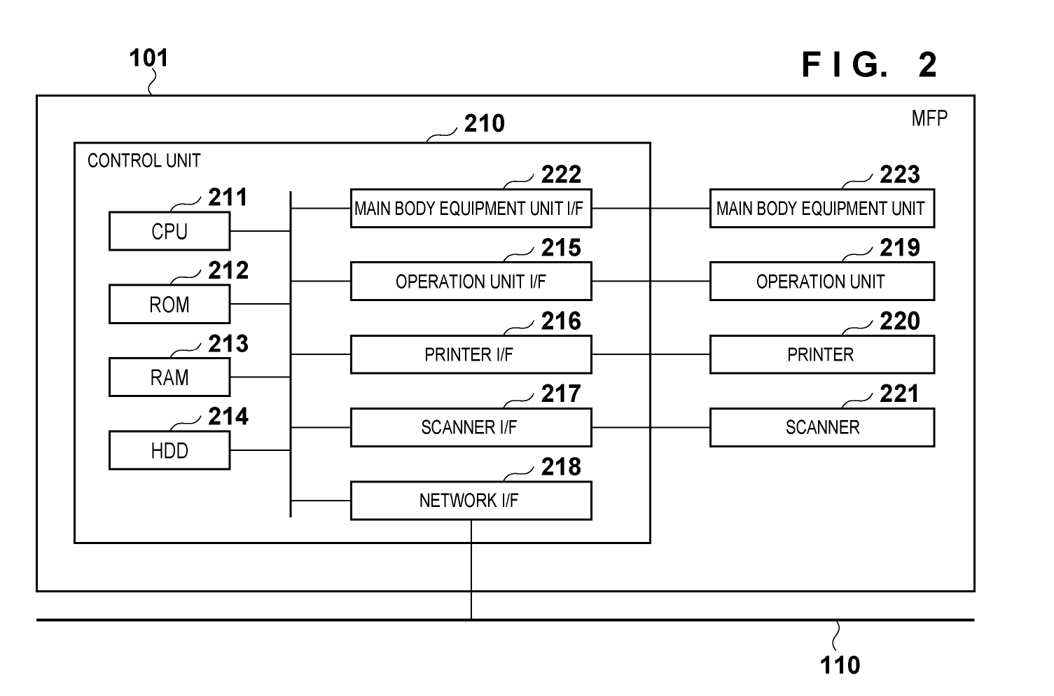

An example of the arrangement of the MFP 101 will be described next with reference to FIG. 2. The MFP 101 includes a control unit 210, an operation unit 219, a printer 220, a scanner 221, and a main body equipment unit 223. The control unit 210 includes a CPU 211, a ROM 212, a RAM 213, an HDD 214, an operation unit I/F 215, a printer I/F 216, a scanner I/F 217, a network I/F 218, and a main body equipment unit I/F 222.

The control unit 210 comprehensively controls the operation of the MFP 101. The CPU 211 reads out control programs stored in the ROM 212 and executes various kinds of control processing such as read control and transmission control. The RAM 213 is used as a main memory and a temporal storage area such as a work area for the CPU 211. The HDD 214 stores image data, various kinds of programs, and various kinds of information tables (to be described later).

The operation unit I/F 215 connects the operation unit (display unit) 219 to the control unit 210. The operation unit 219 includes a liquid crystal display unit having a touch panel function and a keyboard. The MFP 101 has a Web browser function (to be described later). The Web browser of the MFP 101 analyzes an HTML file (screen information) received from the Web server 103 and displays the operation screen based on the description of the received HTML file on the operation unit 219.

The printer I/F 216 connects the printer 220 to the control unit 210. The control unit 210 transfers image data to be printed by the printer 220 to the printer 220 via the printer I/F 216. The printer 220 then prints an image on a recording medium. The scanner I/F 217 connects the scanner 221 to the control unit 210. The scanner 221 reads an image on a document to generate image data, and inputs it to the control unit 210 via the scanner I/F 217. The network I/F 218 connects the control unit 210 (MFP 101) to the LAN 110. The network I/F 218 transmits image data or information to an external apparatus (for example, the Web server 103) on the LAN 110, and receives various kinds of information from the external apparatus on the LAN 110.

The main body equipment unit I/F 222 is connected to the main body equipment unit 223 including various kinds of equipment of the MFP main body, for example, a card reader, a cassette unit, and a platen cover/document feeder. When the user inserts/removes a card in/from the card reader or performs operation for a given paper drawer of the cassette unit or the platen cover/document feeder, an event indicating the occurrence of the operation is notified to the main body equipment unit I/F 222. Although a detailed description of an operation event will be omitted, there is available, for example, a method of detecting the occurrence of operation using a sensor for each equipment and notifying it.

<Arrangement of Web Server>

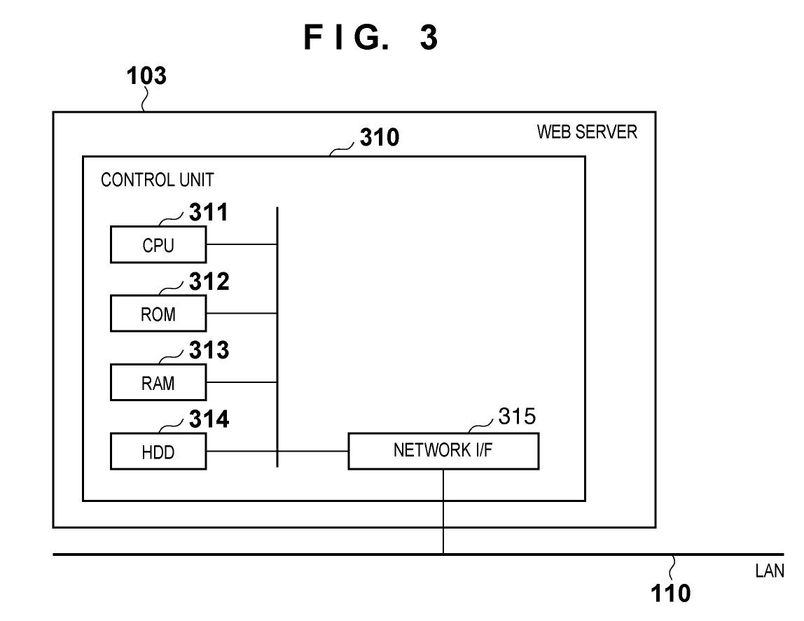

An example of the arrangement of the Web server 103 will be described next with reference to FIG. 3. Note that the LDAP server 102 has the same arrangement as that of the Web server 103, and hence a description of it will be omitted. The Web server 103 includes a control unit 310. The control unit 310 includes a CPU 311, a ROM 312, a RAM 313, an HDD 314, and a network I/F 315.

The control unit 310 comprehensively controls the operation of the Web server 103. The CPU 311 reads out control programs stored in the ROM 312 and executes various kinds of control processing. The RAM 313 is used as a main memory and a temporal storage area such as a work area for the CPU 311. The HDD 314 stores image data, various kinds of programs, and various kinds of information tables (to be described later). The network I/F 315 connects the control unit 310 (Web server 103) to the LAN 110. The network I/F 315 transmits/receives various kinds of information to/from other apparatuses on the LAN 110.

<Control Arrangement for Information Processing System>

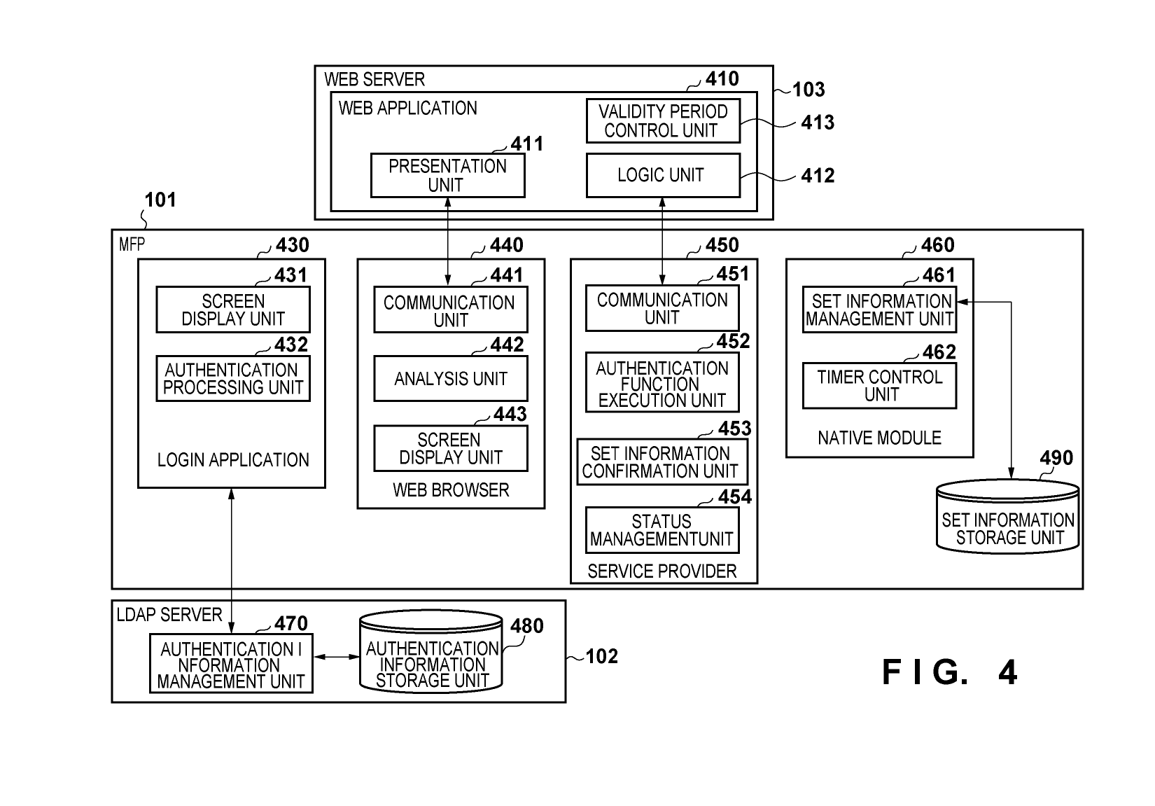

An example of a control arrangement for the overall information processing system 100 will be described next with reference to FIG. 4. The CPUs 211 and 311 respectively provided for the MFP 101, the LDAP server 102, and the Web server 103 implement the respective functional units shown in FIG. 4 by executing control programs. The MFP 101 includes a login application 430, a Web browser 440, a service provider 450, a native module 460, and a set information storage unit 490. The Web server 103 includes a Web application 410. The LDAP server 102 includes an authentication information management unit 470 and an authentication information storage unit 480.

The login application 430 includes a screen display unit 431 and an authentication processing unit 432. When performing authentication processing in the Web application 410 on the MFP 101 side, an authentication function execution unit 452 of the service provider 450 activates the login application 430. The screen display unit 431 displays, on the operation unit 219, an authentication screen for prompting the user to input authentication information necessary for authentication processing executed by the authentication processing unit 432. Note that this authentication screen is not provided by the Web server 103 but is displayed by making the login application 430 read out information held in the MFP 101. A screen displayed based on information held in the MFP 101 in advance will be referred to as a native screen hereinafter. When the user inputs authentication information via the authentication screen displayed by the screen display unit 431, the authentication processing unit 432 performs user authentication by using the input authentication information.

The authentication information storage unit 480 of the LDAP server 102 stores, in advance, authentication information corresponding to the user who is permitted to use the MFP 101. The authentication information management unit 470 of the LDAP server 102 manages the authentication information stored in the authentication information storage unit 480. When executing authentication processing, the authentication processing unit 432 collates the authentication information input via the authentication screen displayed by the screen display unit 431 with the authentication information stored in the authentication information storage unit 480. The user is permitted to use the MFP 101 in accordance with this collation result.

The Web browser 440 includes a communication unit 441, an analysis unit 442, and a screen display unit 443. The communication unit 441 communicates with a presentation unit 411 of the Web application 410 in accordance with an HTTP protocol. More specifically, the communication unit 441 issues a request for an operation screen to be displayed on the Web browser to the Web application 410, or notifies the Web application 410 of an instruction input by the user via the operation screen displayed on the Web browser. The analysis unit 442 analyzes an HTML file received from the Web application 410. This HTML file contains a description (screen information) indicating the contents of an operation screen to be displayed on the Web browser. The screen display unit 443 displays the operation screen on the operation unit 219 based on the analysis result obtained by the analysis unit 442. A screen to be displayed based on the information (HTML file) received from the Web server 103 will be referred to as a Web browser screen hereafter.

The Web application 410 of the Web server 103 includes the presentation unit 411, a logic unit 412, and a validity period control unit 413. The presentation unit 411 communicates with the communication unit 441 of the Web browser 440 to transmit the operation screen to be displayed on the Web browser 440 to the MFP 101 in response to a request from the MFP 101. The presentation unit 411 receives, from the MFP 101, an instruction issued by the user via the operation screen displayed on the Web browser 440. Upon receiving the instruction from the user, the Web application 410 executes various kinds of processing in accordance with the contents of the instruction, and requests the MFP 101 to execute the processing. More specifically, the Web application 410 requests the MFP 101 to execute print processing using the printer 220, execute read processing using the scanner 221, or execute transmission processing via the network I/F 218. When requesting the MFP 101 to execute processing, the logic unit 412 communicates with a communication unit 451 in the service provider 450 provided in the MFP 101.

The validity period control unit 413 controls authentication processing and the validity period of authentication in the Web server 103. In authentication processing, the validity period control unit 413 confirms the authentication in the login user who has logged in to the Web application 410, and notifies the presentation unit 411 of the confirmation result. In addition, the validity period control unit 413 holds the validity period of authentication of the Web server set in advance, and executes read processing or update processing. The validity period control unit 413 also starts a timer for timing the validity period of authentication. When the validity period expires, the validity period control unit 413 performs processing for the expiration of the validity period of authentication. The validity period control unit 413 further resets an authentication validity period time (first timer) in accordance with an instruction from the presentation unit 411 or the logic unit 412. In this case, the validity period of authentication indicates the validity period during which the authenticated user is permitted to use the Web application 410. A validity period indicates a predetermined period of time over which if no user operation is received from the authenticated user, the authentication of the user is automatically disabled.

The service provider 450 includes the communication unit 451, the authentication function execution unit 452, a set information confirmation unit 453, and a status management unit 454. The communication unit 451 accepts a processing request from the logic unit 412 in the Web application 410. When accepting the request to execute processing from the Web application 410, the authentication function execution unit 452 executes the login application 430. The set information confirmation unit 453 acquires various kinds of information set in the MFP 101 by inquiring of the native module 460. For example, the set information confirmation unit 453 acquires and holds information such as an auto clear mode transition time or auto sleep mode transition time from the native module 460.

The status management unit 454 acquires and manages the statuses of various kinds of device information from the native module 460. For example, the status management unit 454 acquires a notification indicating that the user has pressed the hardware key on the operation unit 219 of the MFP 101, inserted/removed a card, or performed operation for the cassette unit, the platen cover, or the document feeder. The status management unit 454 also has a function of notifying the native module 460 of event information such as button operation which the service provider 450 has received from the Web application 410.

The native module 460 includes a set information management unit 461 and a timer control unit 462. The set information management unit 461 reads and writes set value information associated with settings in the MFP 101 which are stored in the set information storage unit 490. The set information storage unit 490 is provided for the HDD 214, RAM 213, or ROM 212 of the MFP 101. It is possible to set and change set value information associated with settings in the MFP 101, stored in the set information storage unit 490, within an arbitrary or set range in accordance with user operation via the operation unit 219. The set value information includes, for example, a time to transition to the auto clear mode (auto clear mode transition time) and a time to transition to the sleep mode (sleep mode transition time). The set value information also includes an MFP logout transition time to be set as a logout time for a login user in the MFP 101 which is associated with these transition times. This system can operate while regarding this MFP logout transition time as equal to a shorter one of the auto clear mode transition time and the sleep mode transition time. The above logout transition time is a predetermined time over which if no user operation is received from the login user, the login user is automatically logged out from the MFP 101.

When the MFP 101 performs operation for a connected device, the timer control unit 462 receives an event indicating the execution of the operation and performs timer control on the MFP 101. Timer control on the MFP 101 includes control on an auto clear mode timer for counting the time to auto clear mode transition and control of a sleep mode timer for counting the time to sleep mode transition. When one of these timers reaches the set value of the auto clear mode transition time or sleep mode transition time, the MFP 101 performs auto clear mode transition or sleep mode transition. The timer control unit 462 further controls an MFP logout timer (second timer) for counting the time to logout of the login user from the MFP 101. This MFP logout timer can operate while regarding the time to logout as equal to a smaller one of the values of the auto clear mode timer and sleep mode timer. That is, when the MFP 101 reaches one of the transition times to auto sleep mode transition and sleep mode transition, user logout is performed.

In addition, the operation for the connected device includes, for example, pressing the hardware key on the MFP operation unit, insertion/removal of a card, and operation associated with the cassette unit, the platen cover, or the document feeder. The timer control unit 462 manages these pieces of operation information (events), that is, the events which have occurred in the main body equipment unit 223, via the main body equipment unit I/F 222. The timer control unit 462 also has a function of notifying the status management unit 454 of information associated with timer resetting.

<Processing Procedure>

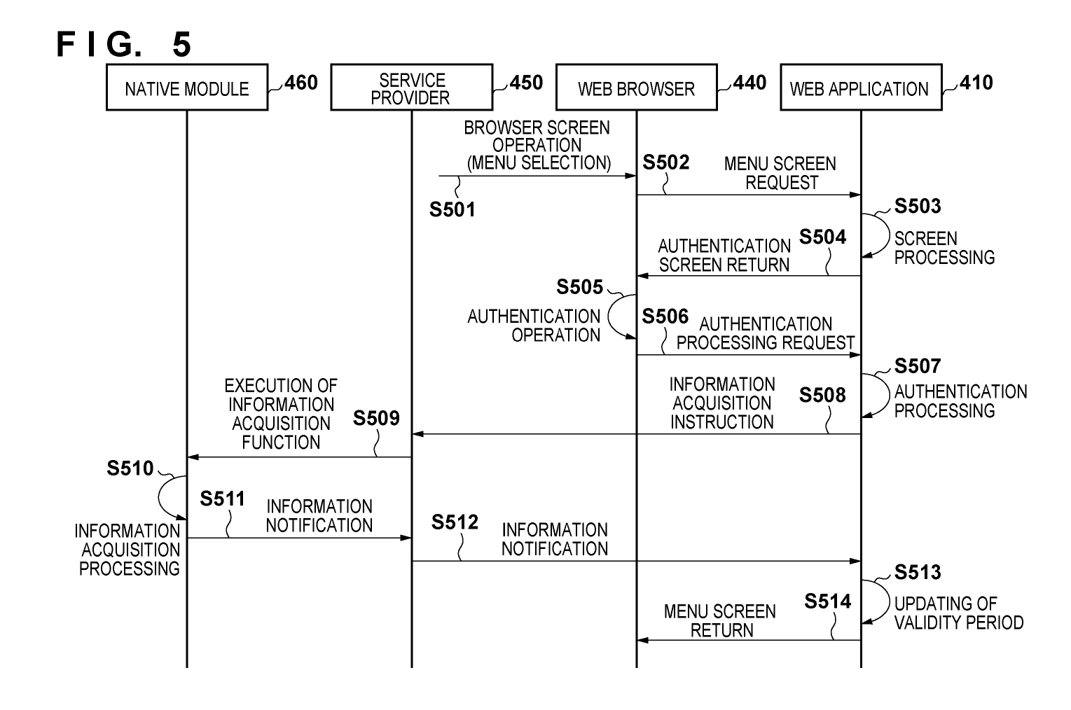

Control characteristic to this embodiment will be described next with reference to FIGS. 5 to 7. In the embodiment, when performing authentication in the Web application 410, the application makes an inquiry about the MFP logout transition time in the MFP 101 via the service provider 450. Thereafter, the validity period control unit 413 updates the validity period of authentication in the Web application 410 in accordance with the acquired MFP logout transition time.

A processing sequence in an apparatus included in the information processing system 100 according to this embodiment will be described first with reference to FIG. 5. In the embodiment, when the user activates the Web browser 440 of the MFP 101, the operation starts from a state in which the function selection screen, from which the user is to select a function, is displayed on the Web browser 440.

In step S501, the Web browser 440 accepts user operation via the function menu displayed by the screen display unit 443. Subsequently, in step S502, the Web browser 440 issues a menu screen request to the Web application 410.

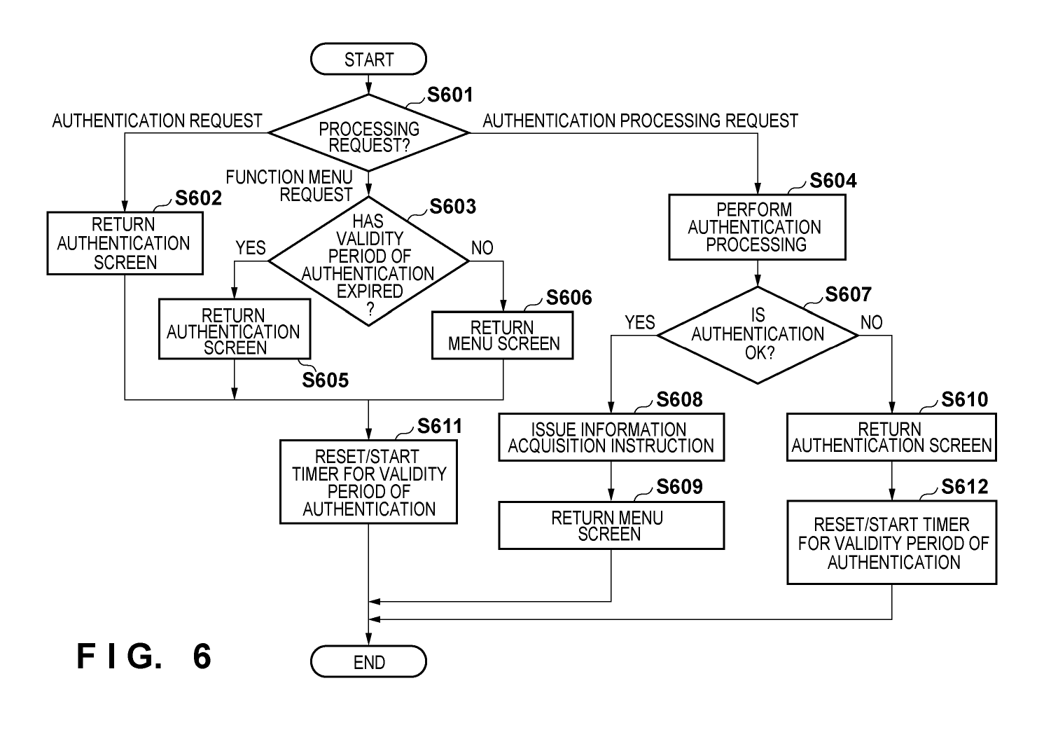

In step S503, the Web application 410 performs screen processing in accordance with the menu screen request issued in step S502. In this screen processing, the Web application 410 generates the screen information of an authentication screen to be notified to the Web browser 440. In step S504, the Web application 410 transmits the generated authentication screen information to the Web browser 440. This processing will be described in detail later with reference to FIG. 6.

In step S505, the Web browser 440 causes the screen display unit 443 to display an authentication screen based on the screen information received from the Web application 410, and accepts user operation via the authentication screen. In step S506, the Web browser 440 notifies the Web application 410 of the authentication information based on the accepted user operation.

In step S507, the Web application 410 executes authentication processing by using the received authentication information. The authentication processing will be described in detail later with reference to FIG. 6. If the authentication succeeds, the Web application 410 issues an information acquisition instruction to the service provider 450 in step S508 to acquire the MFP logout transition time set in the MFP 101.

Upon receiving the information acquisition instruction in step S508, the service provider 450 issues an instruction to the native module 460 to acquire set information in the MFP 101 in step S509. More specifically, the set information confirmation unit 453 inquires of the set information management unit 461 of the native module 460 about the information set in the MFP 101.

In step S510, the set information management unit 461 of the native module 460 acquires set information from the set information storage unit 490. In step S511, the set information management unit 461 notifies the set information confirmation unit 453 of the service provider 450 of the acquired set information. In step S512, the service provider 450 notifies the Web application 410 of the received set information in response to the instruction received in step S508. In step S513, the Web application 410 updates the validity period of authentication held in accordance with the notified MFP logout transition time. Thereafter, in step S514, the Web application 410 transmits the screen information of the menu screen to the Web browser 440.

Screen processing in step S503 and authentication processing in step S507 which are performed by the Web application 410 will be described next with reference to FIG. 6. Note that the CPU 311 of the Web server 103 implements the following processing by loading a program stored in the ROM 312, the HDD 314, or the like into the RAM 313 and executing it.

In step S601, the Web application 410 causes the processing to branch afterward in accordance with the contents of the processing request from the Web browser 440. That is, depending on whether the request is a request for an authentication screen, a function menu screen, or authentication processing, the Web application 410 causes the processing to branch afterward.

If the contents of the processing request indicate a request for an authentication screen, the process advances to step S602. In step S602, the Web application 410 returns the screen information of the authentication screen to the Web browser 440 in response to the processing request to prompt the user to perform authentication processing. Step S602 corresponds to step S504 in FIG. 5. The process then advances to step S611, in which the Web application 410 resets the timer for counting the validity period of authentication, restarts the timer, and terminates the processing.

If the contents of the processing request in step S601 indicate a request for a function menu screen, the process advances to step S603. This indicates that the current login user has already completed authentication, and has kept requesting a menu screen for general functions. In step S603, the Web application 410 checks the validity period of authentication for the user who has issued the screen request, and determines whether the validity period of authentication has expired (a timeout has occurred because of lack of screen request for a predetermined period of time). If the validity period of authentication has expired, the process advances to step S605, in which the Web application 410 returns the screen information of an analysis screen to the Web browser 440 to perform authentication again. Step S605 corresponds to step S504 in FIG. 5 like step S602. In this case, it is possible to return a message prompting the user to perform authentication again upon adding the message to the authentication screen. This message is, for example, as follows: “Authentication validity period has expired. Please authenticate again”. The process then advances to step S611.

If the Web application 410 determines in step S603 that the validity period has not expired, the process advances to step S606, in which the Web application 410 returns a menu screen to the Web browser 440 to make the current login user continue the processing for a general function. Step S606 corresponds to step S514 in FIG. 5. Thereafter, the process advances to step S611. In step S611, the Web application 410 resets the timer for counting the validity period of authentication, restarts the timer, and terminates the processing.

If the Web application 410 determines in step S601 that the contents of the processing request indicate a request for authentication processing, the process advances to step S604. In step S604, the Web application 410 executes authentication processing in accordance with the contents of the processing request. The process advances to step S607, in which the Web application 410 determines whether the authentication is OK or NG. If the authentication is OK, the process advances to step S608, in which the Web application 410 issues an information acquisition instruction to the service provider 450 to acquire the MFP logout transition time set in the MFP 101. In step S609, the Web application 410 returns the screen information of a menu screen to the Web browser 440, and terminates the processing. Step S608 corresponds to step S508 in FIG. 5. Step S609 corresponds to step S514 in FIG. 6.

If the Web application 410 determines in step S607 that the authentication is NG, the process advances to step S610, in which the Web application 410 returns the screen information of an authentication screen to the Web browser 440 to perform authentication again. Step S610 corresponds to step S504 in FIG. 5. Subsequently, the process advances to step S612, in which the Web application 410 resets the timer for counting the validity period of authentication, restarts the timer, and terminates the processing.

The processing in steps S611 and S612 implements a function of resetting the expiration of authentication in the Web application 410 and restarting the timer upon occurrence of a request from the Web browser 440 to the Web application 410. It is also possible to perform the screen processing in step S503 and the authentication processing in step S507 by using the validity period control unit 413 of the Web application 410.

The authentication processing in the Web application 410 has been described by exemplifying the operation using authentication processing performed on the Web server side. However, as described above, the MFP 101 can also perform authentication processing by using the login application 430. In this case, the logic unit 412 of the Web application 410 requests the service provider 450 to perform authentication processing. The service provider 450 causes the authentication function execution unit 452 to activate the login application 430 to execute authentication processing. Subsequently, the Web application 410 receives an authentication result via the service provider 450.

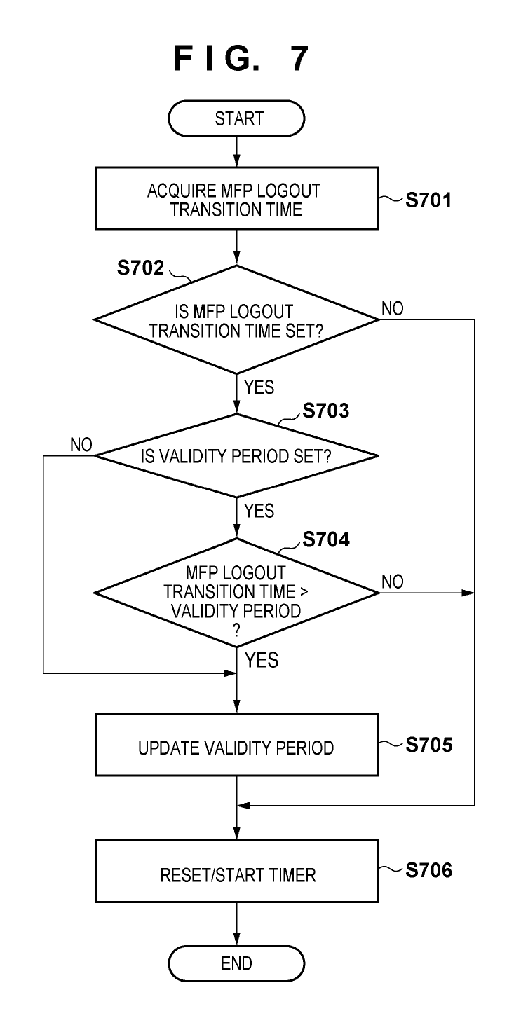

The processing in step S513 will be described in more detail next with reference to FIG. 7. Note that the CPU 311 of the Web server 103 implements the processing to be described below by loading a program stored in the ROM 312, the HDD 314, or the like into the RAM 313 and executing it.

First of all, in step S701, the Web application 410 acquires the MFP logout transition time. In step S702, the Web application 410 determines whether the MFP logout transition time is actually set. If the MFP logout transition time is set, the process advances to step S703, in which the Web application 410 determines whether the validity period of authentication managed by the validity period control unit 413 is set (not set to infinity). If the Web application 410 determines in step S703 that the validity period of authentication is set, the process advances to step S704. If the validity period of authentication is not set, the process advances to step S705 to set a validity period of authentication.

In step S704, the Web application 410 determines whether the MFP logout transition time is longer than the validity period of authentication managed by the validity period control unit 413. If the Web application 410 determines that the MFP logout transition time is longer than the validity period of authentication, the process advances to step S705. In step S705, the Web application 410 updates the validity period of authentication to set it to the same time as the MFP logout transition time, and the process advances to step S706.

If the Web application 410 determines in step S702 that the MFP logout transition time is not set, the process advances to step S706. In addition, if the Web application 410 determines in step S704 that the MFP logout transition time is not longer than the validity period of authentication, the process advances to step S706. In step S706, the Web application 410 resets the timer for counting the validity period of authentication, restarts the timer, and terminates the processing.

As has been described above, according to this embodiment, a Web application activated on a Web server acquires the information of the logout transition time set in the MFP, and updates the validity period of authentication in the Web application in accordance with the acquired logout transition time. In addition, the Web application receives the notification of an operation event occurring in the MFP in addition to an operation event on the Web application, and properly resets the timer for the validity period of authentication in the Web application. This makes it possible to synchronize the logout transition time in the MFP with the validity period of authentication in the Web application.

### Second Embodiment

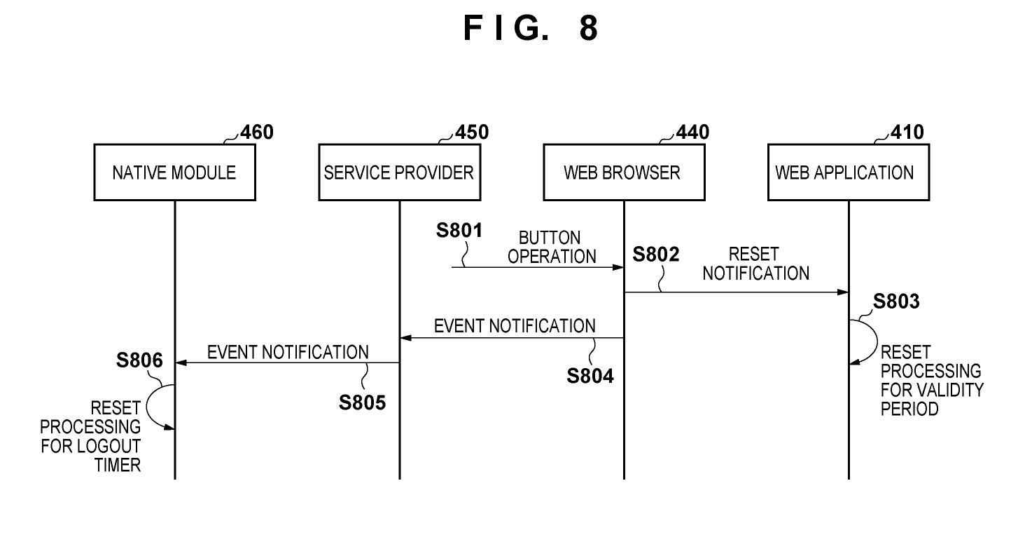

The second embodiment of the present invention will be described next with reference to FIGS. 8 to 10. When, for example, the user operates an MFP 101 without any request to a Web application 410, the timer for the sleep mode transition time or auto clear mode transition time in the MFP 101 is reset. In the above case, this embodiment causes the Web application 410 to reset the timer for the validity period of authentication in accordance with the corresponding information and restart the timer.

With reference to FIG. 8, the following describes the resetting of the timer for MFP logout corresponding to the sleep mode transition time or auto clear mode transition time in the MFP 101 and the resetting of the timer for the validity period of authentication in the Web application 410 in accordance with operations on the Web browser 440. First of all, in step S801, the Web browser 440 accepts user operation via the menu screen displayed by the screen display unit 443. In step S802, the Web browser 440 requests the Web application 410 to perform processing in accordance with the user operation. In this step, it is possible to issue a request for a menu screen in step S502 described above or a request for authentication processing in step S506 described above.

In step S803, the Web application 410 resets the timer for counting the validity period of authentication. In step S804, the Web browser 440 notifies the Web application 410 of the request issued by the user operation (button operation) in step S801, and also notifies a service provider 450 of the occurrence of the event of the button operation.

In step S805, the service provider 450 notifies a native module 460 of the occurrence of the event via a status management unit 454. In step S806, the native module 460 then causes a timer control unit 462 to reset the MFP logout timer on the MFP 101 side and restarts the timer upon receiving the event notification. In step S806, the native module 460 may reset the auto clear mode timer or sleep mode timer described above in addition to the MFP logout timer. Resetting these timers simultaneously can synchronize the timers for the auto clear mode transition time, sleep mode transition time, and MFP logout transition time for the MFP 101. With this series of operations, when the user performs button operation on the Web browser 440, the MFP logout timer on the MFP 101 side and the timer for the validity period of authentication in the Web application 410 are simultaneously reset and restarted.

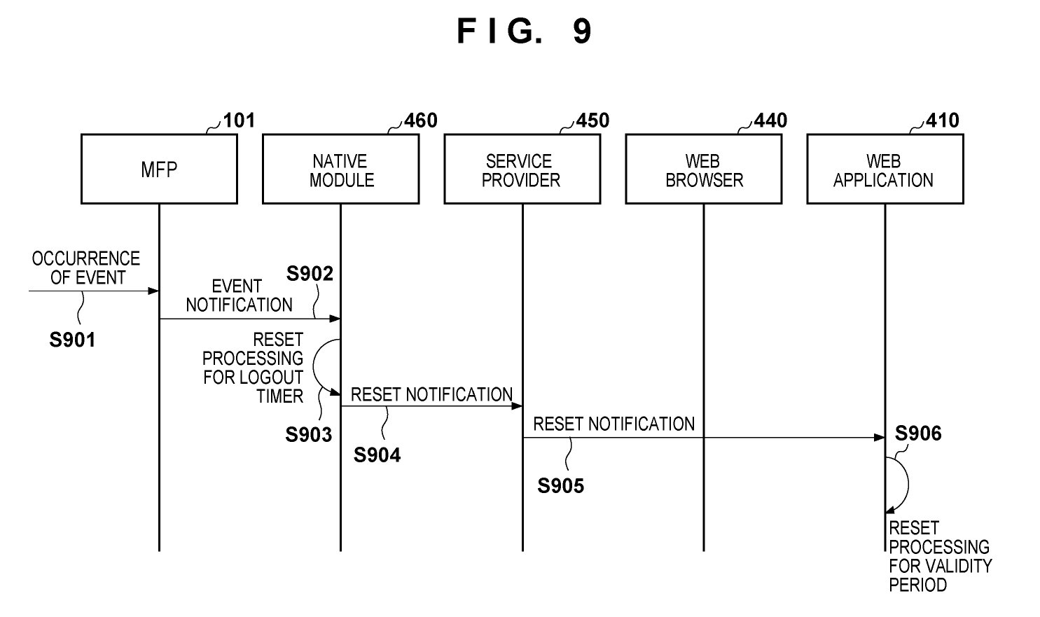

With reference to FIG. 9, the following describes the resetting of the timer for MFP logout corresponding to the sleep mode transition time or auto clear mode transition time in the MFP 101 and the resetting of the timer for the validity period of authentication in the Web application 410 upon operation on the MFP 101. In this case, the operation on the MFP 101 indicates operation different from operation on the Web browser 440. For example, this operation includes pressing the hardware key provided on the MFP 101.

First of all, in step S901, the MFP 101 accepts an operation event originating from user operation or the like via a main body equipment unit 223. In step S902, the main body equipment unit I/F 222 notifies the native module 460 of this operation event. In step S903, the native module 460 causes the timer control unit 462 to reset the MFP logout timer in accordance with the received event information. The process then advances to step S904, in which the native module 460 notifies the service provider 450 of reset notification information indicating that the MFP logout timer has been reset and restarted.

The status management unit 454 of the service provider 450 processes the reset notification notified from the native module 460 in step S904. In step S905, upon receiving the timer reset notification in the MFP 101, the status management unit 454 notifies the Web application that the timer has been reset in the MFP 101. In step S906, the Web application 410 resets the timer for the validity period of authentication and restarts it upon receiving the timer reset notification. With this series of operations, when an event associated with MFP timer resetting in the MFP 101 occurs, the MFP logout timer on the MFP 101 side and the timer for the validity period of authentication in the Web application 410 are simultaneously reset and restarted.

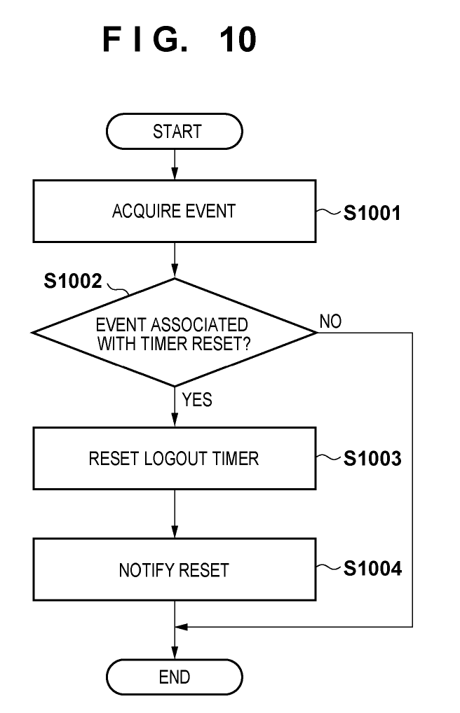

Steps S903 and S904 described above will be described in detail next with reference to FIG. 10. A CPU 211 of the MFP 101 implements the following processing by loading a program stored in a ROM 212 or an HDD 214 to the RAM 213 and executing it.

First of all, in step S1001, the timer control unit 462 of the native module 460 acquires an operation event. In step S1002, the timer control unit 462 determines whether the operation event is an event associated with timer resetting. As described above, this kind of operation event includes, for example, insertion/removal of a card in/from the card reader, operation on each paper drawer of the cassette unit, and opening/closing of the platen cover/document feeder. If the timer control unit 462 determines in step S1002 that the event is not an event associated with timer resetting, the processing is immediately terminated.

If the timer control unit 462 determines that the event is associated with timer resetting, the process advances to step S1003, in which the timer control unit 462 resets and restarts the MFP logout timer. In step S1004, the native module 460 notifies the service provider 450 of reset notification information indicating that the MFP logout timer has been reset and restarted, and terminates the processing. Step S1004 corresponds to step S904 in FIG. 9.

In step S1003, the timer control unit 462 may reset the auto clear mode timer and the sleep mode timer in addition to the MFP logout timer. Resetting these timers simultaneously can synchronize the timers for the auto clear mode transition time, sleep mode transition time, and MFP logout transition time for the MFP 101.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-181855 filed on Aug. 16, 2010, which is hereby incorporated by reference herein in its entirety.

What is claimed is:

1. An information processing system comprising a Web server and an information processing apparatus including a Web browser for displaying an operation screen provided by said Web server,
said Web server comprising
an authentication unit that executes authentication of a user who is to use said Web browser via a screen of said Web browser displayed on said information processing apparatus,
a transition time requesting unit that requests a notification from said information processing apparatus of a logout transition time indicating a predetermined period of time which is set in said information processing apparatus and over which if no user operation is received, a user who has logged in to said information processing apparatus is automatically logged out, when authentication by said authentication unit succeeds, and
an updating unit that updates a validity period of authentication which is a predetermined period of time over which if user operation by a user authenticated by said authentication unit is not received, authentication of the user is automatically disabled, in accordance with the logout transition time acquired from said information processing apparatus in response to a request from said transition time requesting unit, and
said information processing apparatus comprising
an authentication requesting unit that requests said Web server to authenticate the user, when the user is to use said Web browser, and
a transition time notifying unit that acquires a logout transition time held in advance from a memory and notifies said Web server of the acquired logout transition time, when said transition time requesting unit issues a request to notify the logout transition time.

2. The system according to claim 1, wherein said update unit comprises a determination unit that determines whether the acquired logout transition time is longer than a validity period of authentication set in said Web server, and
updates the validity period of authentication to the same time as the logout transition time, if the acquired logout transition time is longer than the validity period of authentication set in said Web server.

3. The system according to claim 1, wherein said Web server further comprises a first timer that times the validity period of authentication, and
a disable unit that automatically disables authentication of the authenticated user when said first timer times out, and
said information processing apparatus comprises a second timer that times the logout transition time, and
a logout unit that automatically logs out the login user when said second timer times out.

4. The system according to claim 3, wherein said information processing apparatus further comprises a second timer resetting unit that resets said second timer when receiving user operation via said Web browser or user operation not via said Web browser,
a user operation notifying unit that notifies said Web server of user operation when receiving the user operation via said Web browser, and
a reset notifying unit that notifies said Web server that said second timer has been reset, when said second timer resetting unit has reset said second timer by user operation not via said Web browser, and
said Web server further comprises a first timer resetting unit that resets said first timer, when receiving a notification from said user operation notifying unit or a notification by said reset notifying unit.

5. The system according to claim 4, further comprising a screen information notifying unit that notifies said information processing apparatus of screen information of an authentication screen for reception of authentication information from a user to perform authentication by said authentication unit, when a notification is received from said user operation notifying unit and said first timer has timed out, and notifies screen information of a menu screen, when a notification is received from said user operation notifying unit and said first timer has not timed out.

6. A Web server which is connected to an information processing apparatus comprising a Web browser, the server comprising:
an authentication unit that executes authentication of a user who uses said Web browser via a screen of said Web browser displayed on said information processing apparatus;
a transition time requesting unit that requests a notification from said information processing apparatus of a logout transition time indicating a predetermined period of time which is set in said information processing apparatus and over which if no user operation is received, a user who has logged in to said information processing apparatus is automatically logged out, when authentication by said authentication unit succeeds; and
an updating unit that updates a validity period of authentication which is a predetermined period of time over which if user operation by a user authenticated by said authentication unit is not received, authentication of the user is automatically disabled, in accordance with the logout transition time acquired from said information processing apparatus in response to a request from said transition time requesting unit.

7. An information processing apparatus comprising a Web browser which is connected to a Web server and is used to display an operation screen provided by said Web server, the apparatus comprising:
an authentication requesting unit that requests said Web server to authenticate the user, when the user is to use said Web browser; and
a transition time notifying unit that acquires a logout transition time held in advance from a memory and notifies said Web server of the acquired logout transition time, when receiving a request to notify the logout transition time indicating a predetermined period of time over which if no user operation is received from said Web server after authentication has been succeeded in said Web server, a user who has logged in to the information processing apparatus is automatically logged out.

8. A control method for an information processing system including a Web server and an information processing apparatus including a Web browser for displaying an operation screen provided by the Web server, the method comprising:
causing an authentication requesting unit of the information processing apparatus to request the Web server to perform authentication processing for a user, when the user is to use the Web browser,
causing an authentication unit of the Web server to execute authentication of the user who is to use the Web browser via a screen of the Web browser displayed on the information processing apparatus;
causing a transition time requesting unit of the Web server to request a notification from the information processing apparatus of a logout transition time indicating a predetermined period of time which is set in the information processing apparatus and over which if no user operation is received, a user who has logged in to the information processing apparatus is automatically logged out, when authentication in the causing the authentication unit of the Web server to execute succeeds;
causing a transition time notifying unit of the information apparatus to acquire a logout transition time held in advance from a memory and notifies the Web server of the acquired logout transition time, when a request to notify the logout transition time is issued in the causing the transmission time requesting unit of the Web server to request; and
causing an updating unit of the Web server to update a validity period of authentication which is a predetermined period of time over which if user operation by a user authenticated in executing authentication is not received, authentication of the user is automatically disabled, in accordance with the logout transition time acquired from the information processing apparatus in response to a request in the causing the transmission time requesting unit of the Web server to request.

9. A control method for a Web server which is connected to an information processing apparatus including a Web browser, the method comprising:
causing an authentication unit to execute authentication of a user who uses the Web browser via a screen of the Web browser displayed on the information processing apparatus;
causing a transition time requesting unit to request a notification from the information processing apparatus of a logout transition time indicating a predetermined period of time which is set in the information processing apparatus and over which if no user operation is received, a user who has logged in to the information processing apparatus is automatically logged out, when authentication succeeds in the causing the authentication unit to execute; and
causing an updating unit to update a validity period of authentication which is a predetermined period of time over which if user operation by a user authenticated in the causing the authentication unit to execute is not received, authentication of the user is automatically disabled, in accordance with the logout transition time acquired from the information processing apparatus in response to a request in the causing the transition time requesting unit to request.

10. A control method for an information processing apparatus including a Web browser which is connected to a Web server and is used to display an operation screen provided by the Web server, the method comprising:
causing an authentication requesting unit to request the Web server to authenticate the user, when the user is to use the Web browser; and
causing a transition time notifying unit to acquire a logout transition time held in advance from a memory and notifies the Web server of the acquired logout transition time, when receiving a request to notify the logout transition time indicating a predetermined period of time over which if no user operation is received from the Web server after authentication has been succeeded in the Web server, a user who has logged in to the information processing apparatus is automatically logged out.

11. A computer-readable storage medium storing a computer program for causing a computer to execute a control method for an information processing system defined in claim 8.

12. A computer-readable storage medium storing a computer program for causing a computer to execute a control method for a Web server defined in claim 9.

13. A computer-readable storage medium storing a computer program for causing a computer to execute a control method for an information processing apparatus defined in claim 10.
